(19) United States
(12) Patent Application Publication
(10) Pub. No.: US 2025/0163264 A1
(43) Pub. Date: May 22, 2025

(54) LIQUID CRYSTAL POLYESTER RESIN COMPOSITION, MOLDED ARTICLE, AND ELECTRONIC COMPONENT MATERIAL COMPRISING THE SAME

(71) Applicant: SE YANG POLYMER CO., LTD., Incheon (KR)

(72) Inventors: Seung Been SONG, Gyeonggi-do (KR); Sang Don LEE, Gyeonggi-do (KR); Su hak BAE, Seoul (KR); Sun Hwa JANG, Gyeonggi-do (KR); Youn Eung LEE, Daejeon (KR); Jun Ha KIM, Gyeonggi-do (KR)

(21) Appl. No.: 18/892,982

(22) Filed: Sep. 23, 2024

(30) Foreign Application Priority Data
Nov. 22, 2023 (KR) 10-2023-0163329

(51) Int. Cl. C08L 67/04; C08K 3/32

(52) U.S. Cl. CPC C08L 67/04; C08K 3/32; C08L 2205/06; C08L 2205/12

(57) ABSTRACT

The present invention relates to a liquid crystal polyester resin composition, a molded article, and an electronic component material including the same and, more particularly, to a liquid crystal polyester resin composition that has good weld line impact strength and is resistant to dust generation, a molded article, and an electronic component material including the same.

### CROSS-REFERENCE TO RELATED APPLICATIONS

The present application claims priority to Korean Patent Application No. 10-2023-0163329, filed Nov. 22, 2023, herein incorporated by reference in its entirety.

### TECHNICAL FIELD

Embodiments of the present invention relate to a liquid crystal polyester resin composition, a molded article, and an electronic component material including the same and, more particularly, to a liquid crystal polyester resin composition that has good weld line impact strength and is resistant to dust generation, a molded article, and an electronic component material including the same.

### BACKGROUND

A liquid crystal polyester resin refers to a molten polyester resin in which molecular chains in a polymer are aligned in a highly ordered, parallel fashion. This ordered arrangement of molecules is commonly referred to as a liquid crystalline phase or a nematic phase of liquid crystals. These polymer molecules are generally long, thin, and flat, resulting in exceptional mechanical strength, electrical properties, and heat resistance along a long chain of the molecules.

Liquid crystal polyester resin-based compositions offer excellent heat resistance and high fluidity, making them ideal for a wide range of electrical/electronic applications. As small portable devices, such as laptops, become thinner, lighter, and more powerful, demand for liquid crystal polyester resin compositions having good moldability is on the rise.

However, liquid crystal polyester resin compositions are characterized in that a molten polymer does not lose a crystalline structure thereof during flow. Accordingly, when the resin composition is injection molded into an article with a complex shape, weld lines are formed at an interface where resin flows meet during the molding process. These weld lines are very weak, making the molded article susceptible to damage caused by internal/external impact or friction.

In addition, molded articles manufactured from liquid crystal polyester resin compositions are prone to fibrillization, a phenomenon in which the surface of the molded article is peeled off, forming fibrils, due to ultrasonic cleaning or friction with other members. When these molded articles are used as electronic components of an electronic product, foreign matter falling off of a fibrillized region, such as dust or fibrils, can significantly impair the performance of the electronic product.

For example, in the case of electronic components, especially optical devices with lenses, adhesion of particulate contaminants, such as dirt and dust, to the lenses can severely compromise optical properties of the optical devices. Fibrillization can occur during assembly or operation of a camera module. Specifically, when a camera's autofocus function is activated, dust particles can be generated from the surface of components of the camera module due to sliding movement of the components. Dust particles can also be generated when the device is impacted or dropped. With the recent trend toward miniaturization of peripheral devices and accessories used in electronic products, there has been a growing need for an electronic component material that is highly resistant to dust generation and thus is useful as a material for dust-sensitive semiconductor and optical components.

In this regard, Korean Patent Laid-open Publication No. 10-2014-0007792 discloses a liquid crystal polyester resin composition designed to obtain molded articles that are highly resistant to fibrillization.

### SUMMARY

Embodiments of the present invention provide a liquid crystal polyester composition that is resistant to physical damage caused by internal/external friction and internal/external impact, has improved impact strength and weld line impact strength, and minimizes dust generation and fibril formation, and an electronic component material including the same.

In accordance with one aspect of the present invention, there is provided a liquid crystal polyester resin composition including: a liquid crystal polyester resin; a fibril inhibitor; an esterification inhibitor; and fillers.

Preferably, the fibril inhibitor includes a compound comprising a repeat unit derived from an α-olefin and a repeat unit derived from an α, β-unsaturated carboxylic acid or an ester thereof.

Preferably, the fibril inhibitor includes at least one selected from the group consisting of an ethylene-(meth)acrylic acid copolymer, an ethylene-methyl (meth)acrylic acid copolymer, an ethylene-ethyl (meth)acrylic acid copolymer, and an ethylene-butyl (meth)acrylic acid copolymer.

Preferably, the esterification inhibitor includes a phosphite compound.

Preferably, the fillers include carbon-based fillers and inorganic fillers.

Preferably, the liquid crystal polyester resin composition includes: 55 wt % to 85 wt % of the liquid crystal polyester resin; 2 wt % to 8 wt % of the fibril inhibitor; 0.1 wt % to 1.0 wt % of the esterification inhibitor; 1 wt % to 5 wt % of the carbon-based fillers; and 10 wt % to 30 wt % of the inorganic fillers.

Preferably, the carbon-based fillers include at least one selected from the group consisting of carbon black, graphite, and carbon nanotubes.

Preferably, the inorganic fillers include at least one selected from the group consisting of serpentinite, montmorillonite, talc, mica, chlorite, glass flakes, silica, quartz powder, glass beads, glass powder, calcium silicate, aluminum silicate, kaolin, clay, siliceous earth, and wollastonite, iron oxide, titanium oxide, zinc oxide, alumina, calcium carbonate, magnesium carbonate, calcium sulfate, barium sulfate, silicon carbide; silicon nitride, boron nitride, and potassium titanate.

Preferably, the liquid crystal polyester resin composition further includes: a lubricant.

Preferably, a molded article formed of the liquid crystal polyester resin composition has a weld line impact strength of greater than 20 J/m.

Preferably, a molded article formed of the liquid crystal polyester resin composition has a dent depth of less than 21 μm.

Preferably, a molded article formed of the liquid crystal polyester resin composition has a dent volume of less than 11,000,000 m³.

In accordance with another aspect of the present invention, there is provided a molded article manufactured from the liquid crystal polyester resin composition described above.

In accordance with a further aspect of the present invention, there is provided an electronic component material including the liquid crystal polyester resin composition described above.

The liquid crystal polyester resin composition according to the present invention can minimize dust generation caused by internal/external impact or friction without sacrificing inherent properties of a liquid crystal polyester resin, such as good mechanical, thermal, and electrical properties and good flame retardancy.

The liquid crystal polyester resin composition according to the present invention, the molded article, and the electronic component material including the same have good properties in terms of impact strength and weld line impact strength and are resistant to dust generation and fibril formation caused by internal/external friction or impact.

Furthermore, due to resistance to dust generation/fibril formation and good weld line impact strength thereof, the liquid crystal polyester resin composition according to the present invention, the molded article, and the electronic component material including the same can be used as a material for components of electronic products sensitive to internal/external impact and internal/external friction. In particular, when used as a material for components of a camera module, especially components of a camera module of mobile phones, the liquid crystal polyester resin composition according to the present invention can contribute to maintaining or improving optical performance such as pixel count and image quality.

### DETAILED DESCRIPTION OF EMBODIMENTS

Hereinafter, exemplary embodiments of the present invention will be described.

Unless stated otherwise, technical and scientific terms as used herein have a meaning generally understood by those skilled in the art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

In addition, it will be understood that the terms “includes”, “comprises”, “including” and/or “comprising,” when used in this specification, specify the presence of stated elements, but do not preclude the presence or addition of one or more other elements.

In accordance with one aspect of the present invention, a liquid crystal polyester resin composition may include a liquid crystal polyester resin, a fibril inhibitor, an esterification inhibitor, and fillers.

The liquid crystal polyester resin exhibits liquid crystallinity when melted and is preferably melted at a temperature of 450° C. or less.

The liquid crystal polyester resin may have a weight average molecular weight of about 10,000 g/mol to 300,000 g/mol, preferably about 10,000 g/mol to 50,000 g/mol, in view of mechanical strength and injection moldability thereof. If the weight average molecular weight of the liquid crystal polyester resin is less than 10,000 g/mol, the liquid crystal polyester resin composition can have poor mechanical strength, making a molded article manufactured therefrom prone to damage, whereas, if the weight average molecular weight of the liquid crystal polyester resin exceeds 300,000 g/mol, the liquid crystal polyester resin composition can have poor fluidity and thus poor injection moldability.

The liquid crystal polyester resin may be present in an amount of about 55 wt % to about 85 wt %, preferably about 60 wt % to about 80 wt %, more preferably about 65 wt % to about 80 wt %, based on the total weight of the liquid crystal polyester resin composition. If the content of the liquid crystal polyester resin is less than about 55 wt %, the resin composition can have poor fluidity, making micro-injection molding thereof difficult. If the content of the liquid crystal polyester resin component exceeds about 85 wt %, the resin composition can have excessively high fluidity, resulting in deterioration in strength and heat resistance of a molded article or an electronic component manufactured therefrom.

The liquid crystal polyester resin may include at least one selected from the group consisting of a liquid crystal polyester amide, a liquid crystal polyester ether, a liquid crystal polyester carbonate, and a liquid crystal polyester imide.

Preferably, the liquid crystal polyester resin includes a wholly aromatic liquid crystal polyester prepared using only an aromatic compound as a monomer material. Typical examples of the wholly aromatic liquid crystal polyester include: resins prepared by polymerization (polycondensation) of at least one compound selected from the group consisting of aromatic hydroxycarboxylic acids, aromatic dicarboxylic acids, aromatic diols, aromatic hydroxyamines, and aromatic diamines; resins prepared by polymerization of two or more aromatic hydroxycarboxylic acids; resins prepared by polymerization of one or more compounds selected from the group consisting of aromatic dicarboxylic acids, aromatic diols, aromatic hydroxyamines, and aromatic diamines; and resins prepared by polymerization of a polyester such as polyethylene terephthalate with an aromatic hydroxycarboxylic acid.

The liquid crystal polyester resin may be prepared by forming a liquid crystal polyester prepolymer by polycondensation of one or more aromatic monomers, followed by solid-phase polycondensation of the prepolymer. Removal of by-products of the solid-phase polycondensation process may be achieved by purging with an inert gas or evacuation.

The liquid crystal polyester resin used in the resin composition according to the present invention may be prepared by polymerization of one or more monomers selected from the group consisting of, for example, hydroxybenzoic acid (HBA), hydroxynaphthoic acid (HNA), biphenol (BP), terephthalic acid (TPA), and hydroxyacetanilide (APAP).

For example, the liquid crystal polyester resin may be prepared by polymerization of a monomer mixture including 56 mol % to 66 mol % of hydroxybenzoic acid (HBA), 2 mol % to 8 mol % hydroxynaphthoic acid (HNA), 9 mol % to 17 mol % of biphenol (BP), 11 mol % to 21 mol % of terephthalic acid (TPA), and 2 mol % to 8 mol % of hydroxyacetanilide (APAP). Within these content ranges of the aforementioned monomers, the liquid crystal polyester resin can secure fluidity and the resin composition including the same can improve mechanical properties of a final product, such as impact strength, while minimizing dust generation and fibril formation.

The fibril inhibitor according to the present invention can improve resistance of the liquid crystal polyester resin composition to internal/external impact while reducing formation of fibrils. The fibril inhibitor may include a copolymer including a repeat unit derived from an α-olefin and a repeat unit derived from an α,β-unsaturated carboxylic acid or an ester thereof.

The α-olefin may include, for example, C₂ to C₁₀ α-olefins, such as ethylene, propylene, butene, hexene, octene, and the like, specifically ethylene. The α,β-unsaturated carboxylic acid or an ester thereof may include, for example, (meth)acrylic acid, methyl (meth)acrylic acid, ethyl (meth)acrylic acid, butyl (meth)acrylic acid, and the like, preferably methacrylic acid.

As the fibril inhibitor, the copolymer including the repeat unit derived from the α-olefin and the repeat unit derived from the α,β-unsaturated carboxylic acid or the ester thereof may include, for example, an ethylene-(meth)acrylic acid copolymer, an ethylene-methyl (meth)acrylic acid copolymer, an ethylene-ethyl (meth)acrylic acid copolymer, an ethylene-butyl (meth)acrylic acid copolymer, and the like, preferably an ethylene-methacrylic acid copolymer.

The fibril inhibitor may be present in an amount of about 2 wt % to about 8 wt % based on the total weight of the liquid crystal polyester resin composition. If the content of the fibril inhibitor is less than about 2 wt %, the resin composition can have poor impact strength, resulting in increased fibril formation after cleaning of a molded article manufactured therefrom. If the content of the fibril inhibitor exceeds about 8 wt %, fluidity of the resin composition can be changed due to reduction in melt viscosity thereof, making it difficult to obtain a high-quality molded article and causing deterioration in mechanical properties of a molded article manufactured therefrom and increase in dent depth (μm) and dent volume (μm³) of the molded article, resulting in increased dust generation.

The esterification inhibitor may serve to improve or enhance the melt viscosity and weld line impact strength of the liquid crystal polyester resin composition. Since preparation and processing of the liquid crystal polyester resin composition are carried out at a high temperature of about 300° C. to 400° C., additives including the esterification inhibitor and the like are required not to decompose at a high temperature of about 300° C. to 400° C. The esterification inhibitor may include, for example, a phosphite compound and the like, specifically pentadecyl phosphite, hexadecyl phosphite, heptadecyl phosphite, octadecyl phosphite, nonadecyl phosphite, eicosyl phosphite, and the like, preferably at least one selected from the group consisting of heptadecyl phosphite, octadecyl phosphite, and nonadecyl phosphite.

The esterification inhibitor may be present in an amount of about 0.1 wt % to about 1.0 wt % based on the total weight of the liquid crystal polyester resin composition. If the content of the esterification inhibitor is less than about 0.1 wt %, the resin composition can have poor fluidity due to low melt viscosity thereof, making it difficult to obtain a high-quality molded article, and a molded article manufactured therefrom can be prone to damage due to deterioration in impact strength and weld line impact strength thereof. If the content of the esterification inhibitor exceeds about 1.0 wt %, the dent depth (μm) and dent volume (μm³) of a molded article manufactured from the resin composition can be increased and suppression of fibril formation on the surface of the molded article cannot be effectively achieved, causing problems due to dust and fibrils.

A molded article manufactured from the liquid crystal polyester resin composition including the fibril inhibitor and the esterification inhibitor is resistant to fibril formation on the surface thereof and is resistant to damage caused by internal/external impact or friction due to good weld line impact strength thereof.

The fillers may include both carbon-based fillers and inorganic fillers.

The carbon-based fillers may include at least one selected from the group consisting of carbon black, graphite, and carbon nanotubes. These may be used alone or in combination thereof. Preferably, the carbon-based fillers include carbon black. The carbon-based fillers may be present in an amount of about 1 wt % to about 5 wt % based on the total weight of the liquid crystal polyester resin composition. For example, carbon black may be used as the carbon-based fillers to secure light-blocking properties. The carbon black may be present in an amount of about 1 wt % to about 5 wt % based on the total weight of the liquid crystal polyester resin composition. If the content of the carbon black is less than about 1 wt %, blackness of the liquid crystal polyester resin composition can be reduced, making it difficult to secure sufficient light-blocking properties. If the content of the carbon black exceeds about 5 wt %, carbon black particles can agglomerate together rather than being uniformly dispersed in the liquid crystal polyester resin composition, causing deterioration in physical properties of the resin composition and increasing the likelihood of the agglomerates falling off as dust.

The inorganic fillers may serve to improve mechanical strength, heat resistance, and resistance to impact-induced dent of the resin composition. Mixing of the inorganic fillers with the liquid crystal polyester resin is required to be carried out without compromising mechanical properties (strength, stiffness, hardness, etc.), heat resistance, and electrical properties of the polyester resin. The inorganic fillers may include any non-fibrous fillers, such as flake-shaped fillers, particulate fillers, and the like. The inorganic fillers may be present in amount of about 10 wt % to about 30 wt % based on the total weight of the liquid crystal polyester resin composition.

The flake-shaped fillers may serve to improve mechanical properties and heat resistance of the resin composition and impart dimensional stability to a molded article. The flake-shaped fillers may include serpentinite, montmorillonite, talc, mica (black mica, white mica, gold mica, etc.), chlorite, glass flakes, and the like.

The particulate fillers may include: silicates, such as silica, quartz powder, glass beads, glass powder, calcium silicate, aluminum silicate, kaolin, clay, siliceous earth, and wollastonite; metal oxides, such as iron oxide, titanium oxide, zinc oxide, and alumina; metal carbonates, such as calcium carbonate and magnesium carbonate; metal sulfates, such as calcium sulfate and barium sulfate; silicon carbide; silicon nitride; boron nitride; potassium titanate; and the like.

The inorganic fillers may include at least one selected from among the flake-shaped fillers described above, at least one selected from among the particulate fillers described above, or a combination thereof.

The liquid crystal polyester resin composition according to the present invention may further include a lubricant. The lubricant may include, for example, transition metal compounds containing an element belonging to Group VI on the periodic table, specifically a molybdenum compound, a tungsten compound, and chromium compound.

The lubricant can enhance fluidity of the resin composition during high temperature injection molding and can maximize alignment of polymer chains of the liquid crystal polyester resin, thereby improving flexural strength, flexural modulus, impact strength, and weld line impact strength of a molded article while minimizing dust generation and fibril formation caused by internal/external impact or friction.

The lubricant may include a transition metal sulfide containing an element belonging to Group VI on the periodic table, specifically at least one selected from the group consisting of molybdenum disulfide (MoS₂), molybdenum diselenide (MoSe₂), molybdenum selenide sulfide (MoSSe), and molybdenum trioxide (MoO₃), tungsten disulfide (WS₂), tungsten selenide (WSe₂), tungsten selenide sulfide (WSSe), tungsten trioxide (MoO₃), chromium disulfide (CrS₂), chromium diselenide (CrSe₂), chromium selenide sulfide (CrSSe) and chromium trioxide (CrO₃). Preferably, the lubricant includes molybdenum disulfide (MoS₂) or tungsten disulfide (WS₂), more preferably molybdenum disulfide (MoS₂).

The transition metal sulfides have a layered structure in which a layer of a transition metal is sandwiched between two layers of sulfur, and are characterized in that the layers slide easily against each other and have a low coefficient of friction due to a weak van der Waals force between the layers. Among the transition metal sulfides, molybdenum disulfide may be added to plastics to obtain composites with low frictional resistance and high strength, or may be vacuum-deposited on the surface of other materials to obtain self-lubricating composites for high temperature applications.

The lubricant may be present in an amount of greater than about 0.5 wt % and less than about 10 wt %, preferably greater than about 0.5 wt % and less than or equal to about 5 wt %, more preferably about 1 wt % to about 5 wt %, still more preferably about 1 wt % to about 3 wt %, based on the total weight of the liquid crystal polyester resin composition.

If the content of the lubricant is 10 wt % or more, the lubricant cannot be properly dispersed in the liquid crystal polyester resin composition, causing poor extrusion processability of the resin composition and thus very poor mechanical properties of a molded article. Furthermore, such poor mechanical properties of the molded article can result in increased dust generation and fibril formation.

If the content of the lubricant is about 0.5 wt % or less, improvement in mechanical properties of a molded article cannot be sufficiently achieved due to reduction in degree of alignment of polymer chains at a temperature higher than the melting point of the liquid crystal polyester resin, resulting in increased dust generation and fibril formation.

With the use of the fibril inhibitor, the esterification inhibitor, and the fillers, the liquid crystal polyester resin composition according to the present invention can have improved properties in terms of impact strength and dent resistance, thereby minimizing or suppressing dust generation and fibril formation caused by internal/external impact or friction. In addition, the liquid crystal polyester resin composition according to the present invention can minimize the size of dust particles generated from a molded article and the size of fibrils formed on the surface of the molded article while ensuring good weld line impact strength of the molded article. Furthermore, the liquid crystal polyester resin composition according to the present invention can improve impact strength of weld lines appearing on a molded article having a complex structure, thereby minimizing or preventing damage to the molded article caused by internal/external impact. Particularly, when used as a material for components of a camera module, the liquid crystal polyester resin composition according to the present invention can significantly contribute to maintaining or improving optical performance of the camera module, such as pixel count and image quality.

In accordance with other aspects of the present invention, a molded article or an electronic component material may be manufactured from the liquid crystal polyester resin composition including the aforementioned components. The liquid crystal polyester resin composition according to the present invention has improved properties in terms of alignment of polymer chains, thereby allowing the molded article or the electronic component material according to the present invention to have good properties in terms of mechanical strength, including weld line impact strength, and to minimize dust generation and fibril formation. Particularly, when used as a material for components of a camera module of mobile devices such as smartphones, the liquid crystal polyester resin composition according to the present invention can contribute to maintaining or improving optical performance of the camera module, such as pixel count and image quality.

The liquid crystal polyester resin composition according to the present invention may have a melt viscosity of 15 Pa-s to 20 Pa-s, as measured using a melt viscometer after drying of the liquid crystal polyester resin composition.

The liquid crystal polyester resin composition according to the present invention may have an impact strength of greater than 80 kJ/m², as measured on a specimen prepared using an injection molding machine after drying of the liquid crystal polyester resin composition.

The liquid crystal polyester resin composition according to the present invention may have a weld line impact strength of greater than 20 J/m, as measured on a specimen prepared using an injection molding machine after drying of the liquid crystal polyester resin composition.

The liquid crystal polyester resin composition according to the present invention may have a dent depth of less than 21 μm and a dent volume of less than 11,000,000 μm³, as measured on a specimen using a dent simulator, the specimen being prepared using an injection molding machine after drying of the liquid crystal polyester resin composition.

Next, the present invention will be described in more detail with reference to some examples. However, it should be noted that these examples are provided for illustration only and are not to be construed in any way as limiting the present invention.

### Preparative Example: Preparation of Liquid Crystal Polyester Resin

1. After 13,000 g (127.3 mol) of acetic anhydride was placed in a 200 L batch reactor, 20,000 g (144.8 mol) of parahydroxybenzoic acid (HBA), 2,200 g (11.8 mol) of hydroxynaphthoic acid (HNA), 5,400 g (29.3 mol) of biphenol, 6,500 g (39.6 mol) of terephthalic acid (TPA), and 1,570 g (10.4 mol) of hydroxyacetanilide (APAP) were added to the reactor while rotating a stirrer, followed by further adding 12,300 g (120.5 mol) of acetic anhydride, and then the aforementioned components were mixed in the batch reactor.

2. 2.7 g of potassium acetate and 10.8 g of magnesium acetate as catalysts were added to the reactor, followed by injecting nitrogen to create an inert atmosphere inside the reactor.

3. After the reactor was heated over a period of 1 hour to a temperature allowing reflux of the acetic anhydride inside the batch reactor, hydroxyl groups of the monomers were acetylated at this temperature for 2 hours, followed by removal of excess unreacted acetic anhydride and acetic acid resulting from acetylation of the hydroxyl groups. Thereafter, the reactor was heated to 320° C. at a heating rate of 0.5° C./min, thereby preparing a liquid crystal polyester prepolymer, which, in turn, was cooled and solidified while being discharged through a lower valve of the reactor and then was primarily pulverized, thereby obtaining 32,000 g of a liquid crystal polyester prepolymer.

4. The liquid crystal polyester prepolymer was secondarily pulverized using a fine grinder and then introduced into a rotary heating device. Thereafter, polycondensation of the liquid crystal polyester prepolymer was carried out by heating the prepolymer to 200° C. for 2 hours while injecting nitrogen into the rotary heating device at a flow rate of 25 L/min, maintaining the temperature of the prepolymer at 200° C. for 2 hours, heating the prepolymer to 285° C. at a heating rate of 0.2° C./min, and maintaining the temperature of the heating device at 285° C. for 3 hours.

5. After completion of polycondensation of the prepolymer, a liquid crystal polyester resin was finally obtained. The obtained liquid crystal polyester resin had a melting point of 330° C.

### Example 1. Preparation of Liquid Crystal Polyester Resin Composition

1. 76.7 wt % of the liquid crystal polyester resin prepared in Preparative Example (hereinafter “LCP resin”) was mixed with 3 wt % of carbon black, 17 wt % of mica, 2 wt % of an ethylene-methacrylic acid copolymer as a fibril inhibitor, 1 wt % of molybdenum disulfide, and 0.3 wt % of an esterification inhibitor. Details of the aforementioned components are shown in Table 1.

2. The resulting mixture was subjected to melt kneading in a twin-screw extruder (L/D: 44, diameter: 30 mm) at a barrel temperature of 340° C., followed by removal of by-products by evacuation, and then the melt-kneaded mixture was pelletized, thereby preparing a liquid crystal polyester resin composition in pellet form.

3. The prepared pellets were mixed in a mixer (JITD-50KW, JEIL Machinery Co., Ltd.) for 30 minutes and then dried in a hot air dryer (JIB-100KW, JEIL Machinery Co., Ltd.) at 150° C. for 4 hours.

TABLE 1

| Component | Manufacturer and characteristics |
|---|---|
| LCP resin | SEYANG LCP ® G600BB Powder, SEYANG |
| | POLYMER Co., Ltd. |
| Carbon black | HiBlack 30L, Orion Engineered Carbons Co., Ltd. |
| Mica | SM-325W (average particle diameter: 25 μm to 35 |
| | μm), SEOKYUNG CMT Co., Ltd. |
| Fibril inhibitor | NUCREL ™ N1108C, DOW Chemical Co., Ltd. |
| Molybdenum | Molysulfide ® Technical (Fisher Number: |
| disulfide | 3 μm to 4 μm), Climax Molybdenum Company |
| Esterification | ADK STAB AX-71, ADEKA Corporation |
| inhibitor | |

### Examples 2 to 6: Preparation of Liquid Crystal Polyester Resin Composition

Liquid crystal polyester resin compositions were prepared in the same manner as in Example 1 except that the content of each component was changed as listed in Table 2.

TABLE 2

| Component | Example 1 | Example 2 | Example 3 | Example 4 | Example 5 | Example 6 |
|---|---|---|---|---|---|---|
| LCP resin | 76.7 | 74.7 | 72.7 | 70.7 | 74.9 | 74 |
| Carbon black | 3 | 3 | 3 | 3 | 3 | 3 |
| Mica | 17 | 17 | 17 | 17 | 17 | 17 |
| Fibril | 2 | 4 | 6 | 8 | 4 | 4 |
| inhibitor | | | | | | |
| Molybdenum | 1 | 1 | 1 | 1 | 1 | 1 |
| disulfide | | | | | | |
| Esterification | 0.3 | 0.3 | 0.3 | 0.3 | 0.1 | 1.0 |
| inhibitor | | | | | | |

### Comparative Examples 1 to 4: Preparation of Liquid Crystal Polyester Resin Composition

Liquid crystal polyester resin compositions were prepared in the same manner as in Example 1 except that the content of each component was changed as listed in Table 3.

TABLE 3

| | Comparative | Comparative | Comparative | Comparative |
|---|---|---|---|---|
| Component | Example 1 | Example 2 | Example 3 | Example 4 |
| LCP resin | 78.7 | 68.7 | 75 | 73.8 |
| Carbon black | 3 | 3 | 3 | 3 |
| Mica | 17 | 17 | 17 | 17 |
| Fibril inhibitor | — | 10 | 4 | 4 |
| Molybdenum | 1 | 1 | 1 | 1 |
| disulfide | | | | |
| Esterification | 0.3 | 0.3 | — | 1.2 |
| inhibitor | | | | |

### Experimental Example 1: Melt Viscosity of Liquid Crystal Polyester Resin Composition

Melt viscosity of each of the resin compositions of Examples 1 to 6 and Comparative Examples 1 to 4 was measured using a capillary rheometer (RG20, Gottfert Inc.) under conditions of a cylinder temperature of 350° C. and a shear rate of 1,000 s4. Results are shown in Table 4.

### Experimental Example 2: Impact Strength of Liquid Crystal Polyester Resin Composition

From each of the resin compositions of Examples 1 to 6 and Comparative Examples 1 to 4, a specimen having a size of 12.7 mm×65 mm×3.2 mm (width×length×thickness) was prepared.

Unnotched impact strength of the specimen was evaluated in accordance with ASTM D256. Results are shown in Table 4.

### Experimental Example 3: Weld Line Impact Strength of Liquid Crystal Polyester Resin Composition

From each of the resin compositions of Examples 1 to 6 and Comparative Examples 1 to 4, a specimen having a size of 12.4 mm×80 mm×3 mm (width×length×thickness) was prepared. In preparation of the specimen, a gate allowing injection of the resin composition into a mold cavity was positioned on both sides of the mold cavity, allowing weld lines to be formed at a center of the specimen where the resin flows from the two gates meet.

Weld line impact strength was measured by applying impact to a weld line region of the prepared specimen in an unnotched state using an Izod impact tester in accordance with ASTM D256. Results are shown in Table 4.

### Experimental Example 4: Dent Resistance of Liquid Crystal Polyester Resin Composition

1. From each of the resin compositions of Examples 1 to 6 and Comparative Examples 1 to 4, a specimen having a size of 12.4 mm×80 mm×3 mm (width×length×thickness) was prepared by injection molding.

2. The prepared specimen was mounted on a dust simulator, followed by continuously dropping a 15 g ball from a height of 10 cm onto the specimen 70 times.

3. After the continuous drop test, the dent depth (μm) and dent volume (μm³) of the specimen were measured with an optical microscope (XY-GB2, HIROX Co., Ltd.) using a 3D tiling technique.

4. Processes 1 to 3 constituted a single test, which was conducted six times for each specimen, followed by calculating the average dent depth (μm) and average dent volume (μm³). Results are shown in Table 4.

### Experimental Example 5: Resistance to Fibril Formation of Liquid Crystal Polyester Resin Composition

1. From each of the resin compositions of Examples 1 to 6 and Comparative Examples 1 to 4, a specimen having a size of 12.4 mm×80 mm×3 mm (width×length×thickness) was prepared by injection molding and then subjected to conditioning in a constant temperature/constant humidity chamber at 23° C. and 50% RH for at least 8 hours.

2. The specimen was cleaned in an alkali aqueous solution (1%) for 8 minutes and in ultrapure water for 2 minutes at room temperature using a 40 kHz ultrasonic cleaner, followed by drying in a dryer at 80° C. for 30 minutes.

3. The specimen was subjected to air-blowing at room temperature for 10 seconds, followed by observing the presence of fibrils under an optical microscope (XY-GB2, HIROX Co., Ltd.).

4. For each of the resin compositions of Examples 1 to 5 and Comparative Examples 1 to 4, 100 specimens were tested.

5. After completion of Processes 1 to 4, the number of specimens exhibiting fibril formation was counted. When the number of specimens exhibiting fibril formation was 5 or less, a corresponding resin composition was rated as “good”, and when the number of specimens exhibiting fibril formation was more than 5, a corresponding resin composition was rated as “bad”. Evaluation results are shown in Table 4.

TABLE 4

| | | | | | | Number of | |
|---|---|---|---|---|---|---|---|
| | | | | | | specimens | |
| | | | Weld line | | | exhibiting | |
| | Melt | Impact | impact | Dent | Dent | fibril | Resistance |
| | viscosity | strength | strength | depth | volume | formation | to fibril |
| | Pa · s | kJ/m² | J/m | μm | μm³ | Number | formation |
| Example 1 | 18.3 | 90 | 24 | 17.2 | 7,250,844 | 5 | Good |
| Example 2 | 17.7 | 101 | 25 | 17.9 | 7,826,354 | 1 | Good |
| Example 3 | 16.8 | 109 | 25 | 18.5 | 8,466,001 | 0 | Good |
| Example 4 | 16.1 | 115 | 27 | 19.3 | 9,112,901 | 0 | Good |
| Example 5 | 15.4 | 88 | 22 | 17.6 | 7,644,198 | 0 | Good |
| Example 6 | 18.3 | 103 | 25 | 20.2 | 10,337,481 | 4 | Good |
| Comparative | 19.8 | 61 | 20 | 17.3 | 7,234,812 | 37 | Bad |
| Example 1 | | | | | | | |
| Comparative | 10.1 | 120 | 25 | 23.8 | 14,840,811 | 0 | Good |
| Example 2 | | | | | | | |
| Comparative | 9.1 | 44 | 14 | 18.69 | 7,436,243 | 3 | Good |
| Example 3 | | | | | | | |
| Comparative | 15.3 | 104 | 25 | 25.5 | 16,482,994 | 19 | Bad |
| Example 4 | | | | | | | |

The liquid crystal polyester resin compositions of Examples 1 to 6 exhibited melt viscosities of 15 Pa·s to 20 Pa·s. These results indicate that the resin compositions of Examples 1 to 6 had appropriate fluidity for manufacture of a high-quality molded article. Conversely, the liquid crystal polyester resin compositions of Comparative Examples 2 and 3 failed to exhibit appropriate melt viscosity. Inappropriate melt viscosity of the resin composition of Comparative Example 2 can be attributed to the excessive presence of the fibril inhibitor, and inappropriate melt viscosity of the resin composition of Comparative Example 3 can be attributed to the absence of the esterification inhibitor.

The liquid crystal polyester resin compositions of Examples 1 to 6 exhibited good impact strengths of 80 kJ/m² or more, demonstrating resistance to internal/external impact, resistance to dust generation, and stability against internal/external impact or friction. Conversely, the liquid crystal polyester resin compositions of Comparative Examples 1 and 3 exhibited poor impact strengths of less than 80 kJ/m² (Comparative Example 1: about 61 kJ/m², Comparative Example 3: about 44 kJ/m²), indicating a higher susceptibility of a molded article to damage caused by internal/external impact. Poor impact strength of the resin composition of Comparative Example 1 can be attributed to the absence of the fibril inhibitor, and poor impact strength of the resin composition of Comparative Example 3 can be attributed to the absence of the esterification inhibitor.

The liquid crystal polyester resin compositions of Examples 1 to 6 exhibited good weld line impact strengths exceeding 20 J/m, demonstrating resistance to internal/external impact, resistance to dust generation, and stability against internal/external impact or friction. Conversely, the liquid crystal polyester resin compositions of Comparative Examples 1 and 3 exhibited poor weld line impact strengths of 20 J/m or less (Comparative Example: about 20 J/m, Comparative Example 3: about 14 J/m), indicating a higher susceptibility of a molded article to damage caused by internal/external impact. Poor weld line impact strength of the resin composition of Comparative Example 1 can be attributed to the absence of the fibril inhibitor, and poor weld line impact strength of the resin composition of Comparative Example 3 can be attributed to the absence of the esterification inhibitor.

The liquid crystal polyester resin compositions of Examples 1 to 6 exhibited dent depths of less than about 21 μm and dent volumes of about 11,000,000 μm³ or less, demonstrating resistance to dust generation caused by impact. In contrast, the liquid crystal polyester resin composition of Comparative Example 2 exhibited a dent depth of about 23.8 μm and a dent volume of about 14,840,811 μm³ and the liquid crystal polyester resin composition of Comparative Example 4 exhibited a dent depth of about 25.5 μm and a dent volume of 16,482,994 μm³, indicating that the resin compositions of Comparative Examples 2 and 4 had poor dent resistance. Poor dent resistance of the resin composition of Comparative Example 2 can be attributed to the excessive presence of the fibril inhibitor, and poor dent resistance of the resin composition of Comparative Example 4 can be attributed to the excessive presence of the esterification inhibitor.

The liquid crystal polyester resin compositions of Examples 1 to 6 demonstrated high resistance to fibril formation caused by impact or friction, with 5 or fewer out of 100 specimens exhibiting fibril formation. For example, if the number of specimens exhibiting fibril formation exceeds 5, there is a high possibility that fibrils will be detached from the surface of camera module components manufactured from a corresponding resin composition during assembly of a camera module. Deposition of the detached fibrils on a camera lens or the like can cause defects in the camera module. Accordingly, reducing fibril formation can reduce the defect rate during camera module assembly, thus aiding in increase in pixel count associated with higher camera performance.

Conversely, the liquid crystal polyester resin compositions of Comparative Examples 1 and 4 exhibited poor resistance to fibril formation, with 37 specimens exhibiting fibril formation (Comparative Example 1) and 19 specimens exhibiting fibril formation (Comparative Example 4). Poor resistance to fibril formation of the resin composition of Comparative Example 1 can be attributed to the absence of the fibril inhibitor, and poor resistance to fibril formation of the resin composition of Comparative Example 4 can be attributed to the excessive presence of the esterification inhibitor.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention.

1. A liquid crystal polyester resin composition comprising:
a liquid crystal polyester resin;
a fibril inhibitor;
an esterification inhibitor; and
fillers.

2. The liquid crystal polyester resin composition according to claim 1, wherein the fibril inhibitor comprises a compound comprising a repeat unit derived from an α-olefin and a repeat unit derived from an α, β-unsaturated carboxylic acid or an ester thereof.

3. The liquid crystal polyester resin composition according to claim 1, wherein the fibril inhibitor comprises at least one selected from the group consisting of an ethylene-(meth)acrylic acid copolymer, an ethylene-methyl (meth)acrylic acid copolymer, an ethylene-ethyl (meth)acrylic acid copolymer, and an ethylene-butyl (meth)acrylic acid copolymer.

4. The liquid crystal polyester resin composition according to claim 1, wherein the esterification inhibitor comprises a phosphite compound.

5. The liquid crystal polyester resin composition according to claim 1, wherein the fillers comprise carbon-based fillers and inorganic fillers.

6. The liquid crystal polyester resin composition according to claim 5, comprising:
55 wt % to 85 wt % of the liquid crystal polyester resin;
2 wt % to 8 wt % of the fibril inhibitor;
0.1 wt % to 1.0 wt % of the esterification inhibitor;
1 wt % to 5 wt % of the carbon-based fillers; and
10 wt % to 30 wt % of the inorganic fillers.

7. The liquid crystal polyester resin composition according to claim 5, wherein the carbon-based fillers comprise at least one selected from the group consisting of carbon black, graphite, and carbon nanotubes.

8. The liquid crystal polyester resin composition according to claim 5, wherein the inorganic fillers comprise at least one selected from the group consisting of serpentinite, montmorillonite, talc, mica, chlorite, glass flakes, silica, quartz powder, glass beads, glass powder, calcium silicate, aluminum silicate, kaolin, clay, siliceous earth, wollastonite, iron oxide, titanium oxide, zinc oxide, alumina, calcium carbonate, magnesium carbonate, calcium sulfate, barium sulfate, silicon carbide; silicon nitride, boron nitride, and potassium titanate.

9. The liquid crystal polyester resin composition according to claim 1, further comprising: a lubricant.

10. The liquid crystal polyester resin composition according to claim 1, wherein a molded article formed of the liquid crystal polyester resin composition has a weld line impact strength of greater than 20 J/m.

11. The liquid crystal polyester resin composition according to claim 1, wherein a molded article formed of the liquid crystal polyester resin composition has a dent depth of less than 21 μm.

12. The liquid crystal polyester resin composition according to claim 1, wherein a molded article formed of the liquid crystal polyester resin composition has a dent volume of less than 11,000,000 m³.

13. A molded article manufactured from the liquid crystal polyester resin composition according to claim 1.

14. An electronic component material comprising the liquid crystal polyester resin composition according to claim 1.
